(19) United States
(12) Patent Application Publication
(10) Pub. No.: US 2024/0215758 A1
(43) Pub. Date: Jul. 4, 2024

(54) AIR FRYER WITH MULTIPLE VERTICALLY-STACKED COOKING COMPARTMENTS

(71) Applicant: Hamilton Beach Brands, Inc., Glen Allen, VA (US)

(72) Inventors: Derek McCullough, Richmond, VA (US); Drew Carlson, Midlothian, VA (US)

(21) Appl. No.: 18/390,311

(22) Filed: Dec. 20, 2023

Related U.S. Application Data
(60) Provisional application No. 63/436,519, filed on Dec. 31, 2022.

(51) Int. Cl. A47J 37/06; A47J 36/32; F24C 7/08; F24C 15/32

(52) U.S. Cl. CPC A47J 37/0641; A47J 36/32; F24C 7/087; F24C 15/325

(57) ABSTRACT

An air frying cooking appliance includes: a housing; a first cooking compartment defined in the housing having an open front side, a first heating compartment located directly above the first and cooking compartment, the first heating compartment having a first heating element; a first fan positioned to provide air to the first heating compartment; a first cooking basket having a front wall and a cooking container, the cooking container configured to removably reside in the first cooking compartment; and a first handle pivotally mounted to the front wall of the first cooking basket, the first handle being movable between a retracted position, in which a grasping portion of the first handle is generally parallel with the front wall of the first cooking basket, and an extended position, in which the grasping portion of the first handle is generally normal to the front wall of the first cooking basket.

### RELATED APPLICATION

The present application claims priority from and the benefit of U.S. Provisional Patent Application No. 63/436,519, filed Dec. 31, 2022, the disclosure of which is hereby incorporated herein by reference in full.

### FIELD OF THE INVENTION

The present invention is directed generally to cooking appliances, and more specifically to air-frying appliances.

### BACKGROUND

Air fryers are a relatively new innovation in home cooking. Traditionally, deep fat fryers have been used to cook French fries and numerous other food products (e.g., chicken, fish, onion rings, etc.). These food products can be prepared from frozen, refrigerated, ambient, or above ambient temperature conditions. Some consumers place a high value on healthier foods that are prepared using less oils or fats, and the replacement of the deep fat frying process with air frying eliminates a significant amount of oil and fat absorption into the food product. But, while consumers desire healthier foods prepared with less fat and oil, they still desire the taste, texture and mouth feel associated with the deep fat frying process.

Most air fryers have a base in which a cooking vessel resides, and a lid that includes a heating element and a fan. The heating element heats air that is blown downwardly into the vessel. Typically, the vessel is slotted or includes a rack for the food that allows air to circulate on all sides of the food.

Air frying can be somewhat time-consuming. For example, a typical batch of French fries to serve 3-4 people may take 15-20 minutes, and a typical batch of fried chicken “nuggets” may take even longer Thus, if both are to be cooked in the same air fryer and served at the same meal, not only will cooking take quite some time, but the dish fried first may have cooled by the time the second dish has finished frying. Alternatively, the consumer may utilize multiple air fryers, but most consumers would prefer not to own multiple air fryers, due to both cost and reduced counter space.

It may be desirable to provide a single air fryer that can address the above-described issues.

### SUMMARY

As a first aspect, embodiments of the invention are directed to an air frying cooking appliance. The appliance comprises: a housing; a first cooking compartment defined in the housing and having an open front side, a first heating compartment located directly above the first cooking compartment, the first heating compartment having a first heating element; a first fan positioned to provide air to the first heating compartment; a first cooking basket having a front wall and a cooking container, the cooking container configured to removably reside in the first cooking compartment; and a first handle pivotally mounted to the front wall of the first cooking basket, the first handle being movable between a retracted position, in which a grasping portion of the first handle is generally parallel with the front wall of the first cooking basket, and an extended position, in which the grasping portion of the first handle is generally normal to the front wall of the first cooking basket.

As a second aspect, embodiments of the invention are directed to a cooking appliance comprising: a housing; a first cooking compartment defined in the housing and having an open front side, a first heating compartment located directly above the first cooking compartment, the first heating compartment having a first heating element; a first fan positioned to provide air to the first heating compartment; a first cooking basket having a front wall and a cooking container, the cooking container configured to removably reside in the first cooking compartment; and a first splatter shield removably interposed between the first cooking basket and the first heating compartment, the first splatter shield comprising a main panel, the main panel including apertures allowing air to flow from the first heating compartment to the first cooking compartment. The apertures are arranged on the main panel of the first splatter shield so that solid portions of the main panel are directly beneath the heating element.

### BRIEF DESCRIPTION OF THE FIGURES

FIG. 1 is a perspective view of a multi-compartment air fryer according to embodiments of the invention, wherein both of the cooking baskets are arranged in a cooking position.

FIG. 2 is a perspective view of the air fryer of FIG. 1, wherein the lower cooking basket is moved to an access position.

FIG. 3 is a partial cutaway perspective view of the air fryer of FIG. 1, with the housing removed to enable the recirculation system to be viewed.

FIG. 4 is a side perspective view of one of the cooking baskets of the air fryer of FIG. 1, where the handle is shown in its extended position.

FIG. 5 is another side perspective view of the cooking basket of FIG. 4 shown with the handle extended.

FIG. 6 is a side perspective view of the cooking basket of FIG. 4 shown with the handle retracted.

FIG. 7 Is a perspective view of the handle of the cooking basket of FIG. 4.

FIG. 8 is a top perspective section view of the front wall of the cooking basket of FIG. 4, showing how the post of the handle is captured.

FIG. 9 Is a side perspective view of the cooking basket of FIG. 4 with the front wall removed.

FIG. 10 is a side perspective section view of the cooking basket of FIG. 4 located within one of the cooking compartments of the air fryer of FIG. 1.

FIG. 11 is a greatly enlarged cutaway perspective view of the cooking basket of FIG. 1 with the front panel of the front wall removed to expose the locking mechanism, wherein the handle is in the retracted position.

FIG. 12 Is a greatly enlarged cutaway side perspective view of the handle and locking mechanism of the cooking basket of FIG. 4, wherein the handle is in the retracted position.

FIG. 13 is a cutaway perspective view of the cooking basket of FIG. 4 with the front panel of the front wall removed, where in the handle is in the extended position.

FIG. 14 Is a cutaway, opposite side perspective view of the cooking basket of FIG. 13.

FIG. 15 is the front view of one of the cooking compartments of the air fryer of FIG. 1, with much of the front wall of the cooking basket removed.

FIG. 16 is a schematic top view of the air fryer of FIG. 1 illustrating movement of the handle from the retracted to the extended position.

FIG. 17 is a schematic perspective view of the air fryer of FIG. 1 illustrating manipulation of the push button to enable the handle to move from the extended position to the retracted position.

FIG. 18 is a cutaway top perspective view of the air fryer of FIG. 1 with the ceiling, heat insulator and heat reflector removed to allow viewing of the heating element and splatter shield.

FIG. 19 is a perspective view of the splatter shield shown in FIG. 18.

FIG. 20 is a partial cutaway perspective view illustrating the splatter shield mounted in the frame.

FIG. 21 Is a side cutaway side perspective view of the air fryer of FIG. 1 with the housing removed to show showing the recirculation system for both cooking compartments and the cover of the blower housing shown as transparent.

FIG. 22 is a section view of one of the cooking compartments and one of the heating compartments of the air fryer of FIG. 1.

FIG. 23 is a cutaway side perspective view of one of the blower housings of the air fryer of FIG. 1, with the ceiling and side wall of the housing removed and the cover of the blower housing shown as transparent.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

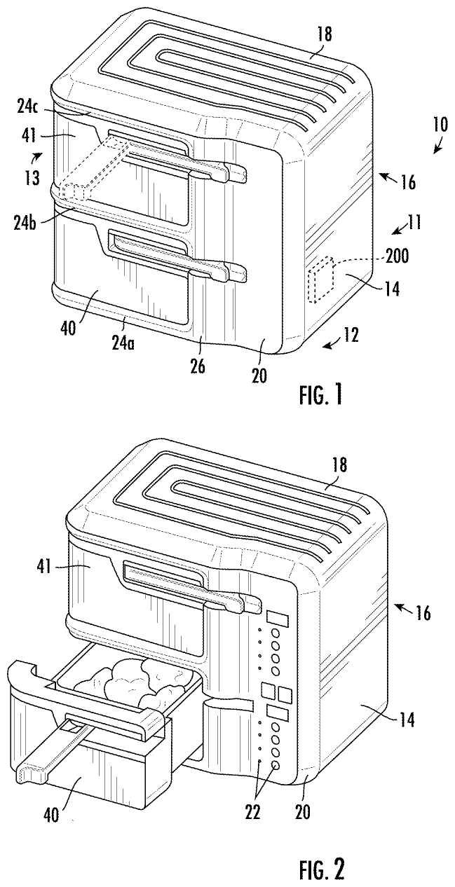

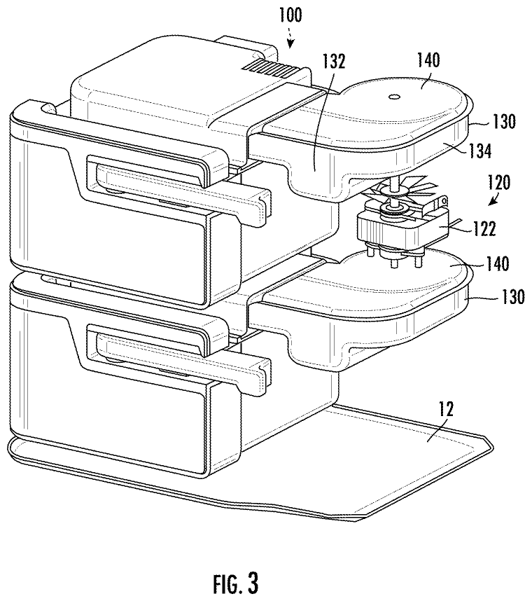

Referring now to the drawings, a multi-compartment air fryer, designated broadly at 10, is shown in FIG. 1. The air fryer 10 has a generally box-shaped housing 11 that includes a floor 12, side walls 13, 14, a rear wall 16, and a ceiling 18. The front of the air fryer 10 includes a panel 20 that covers a side portion of the front of the air fryer 10, and which has controls 22 mounted thereon that are connected with a controller 200 (depicted schematically in FIG. 1). Three cross-members 24a, 24b, 24c extend horizontally across the front of the air fryer between a vertical support 26 and the side wall 13.

Two substantially identical cooking baskets 40, 41, each with a front wall 42, reside within the housing 11, with the lower cooking basket 40 positioned below the cross-member 24b and the upper cooking basket 41 positioned above the cross-member 24b. As in the illustrated embodiment the cooking baskets 40, 41 are substantially identical, in some instances only the cooking basket 40 will be described in detail below, with the understanding that the discussion is equally applicable to the cooking basket 41.

Referring to FIGS. 4-6, each of the cooking baskets 40, 41 includes a front wall 42 and a cooking container 53 with a rear wall 50, side walls 52, and a floor 51 that may be covered by a cooking grate 56. The front wall 42 includes a front panel 47 and a rear panel 49. The upper edges of the rear wall 50 and the side walls 51 merge with a rim 54. As seen in FIG. 1 the front panels 47 of the front walls 42 of the cooking baskets 40, 41 are recessed rearwardly from the front surfaces of the cross-members 24a, 24b, 24c, such that the front of the air fryer 10 presents discontinuous surfaces.

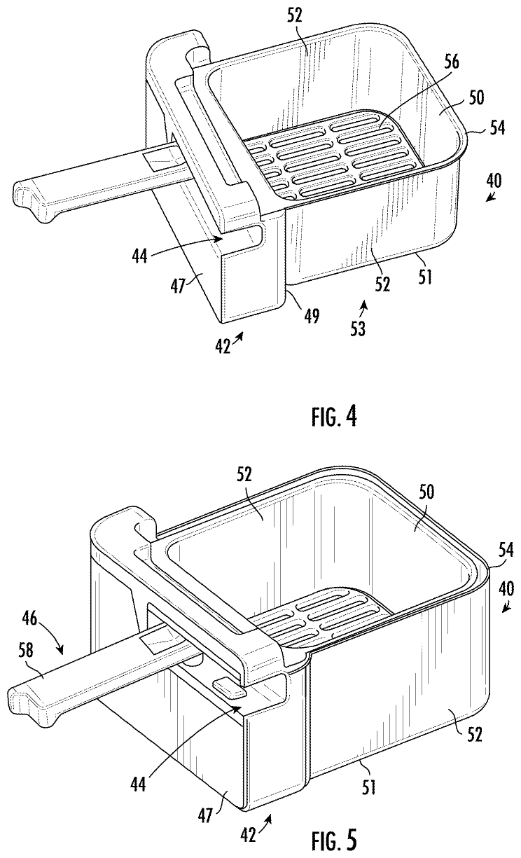

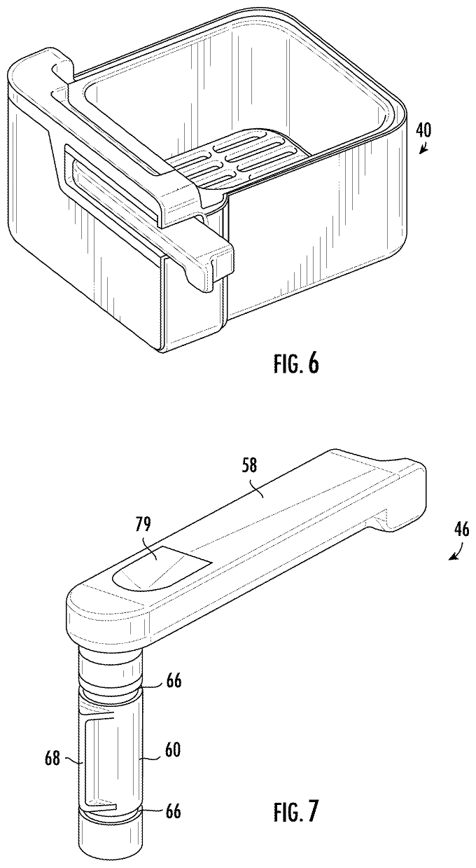

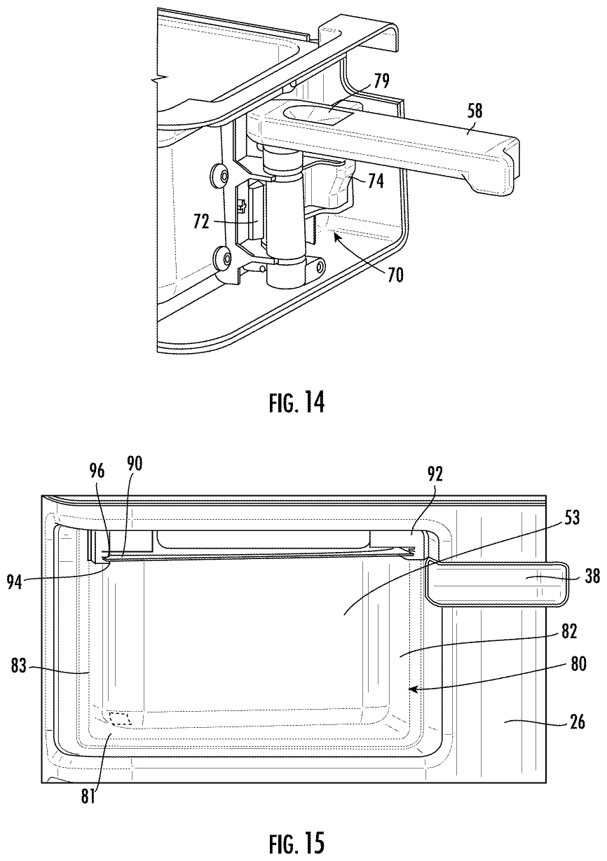

Referring to FIG. 7, to assist with the handling of the cooking baskets 40, 41, each of the cooking baskets 40, 41 includes a pivoting handle 46. Each handle 46 includes a horizontal grasping portion 58 and a vertical post 60 that is captured within the front wall 42. The handle 46 can be pivoted between an extended position (FIG. 5), in which the grasping portion 58 extends forwardly from the front wall 42, and a retracted position (FIG. 6), in which the grasping portion 58 resides in a recess 44 in the front wall 42 and a recess 38 (see FIG. 15) in the vertical support 26 of the housing 11. In the extended position of FIG. 5, the handle 46 can be easily grasped by the user to insert or remove the cooking basket 40 from the housing 11 and to manipulate the cooking basket 40 for the loading and/or unloading of food. In the retracted position of FIG. 6, the handle 46 pivots out of the way to reduce the size of the air fryer 10 for storage, shipping, etc.

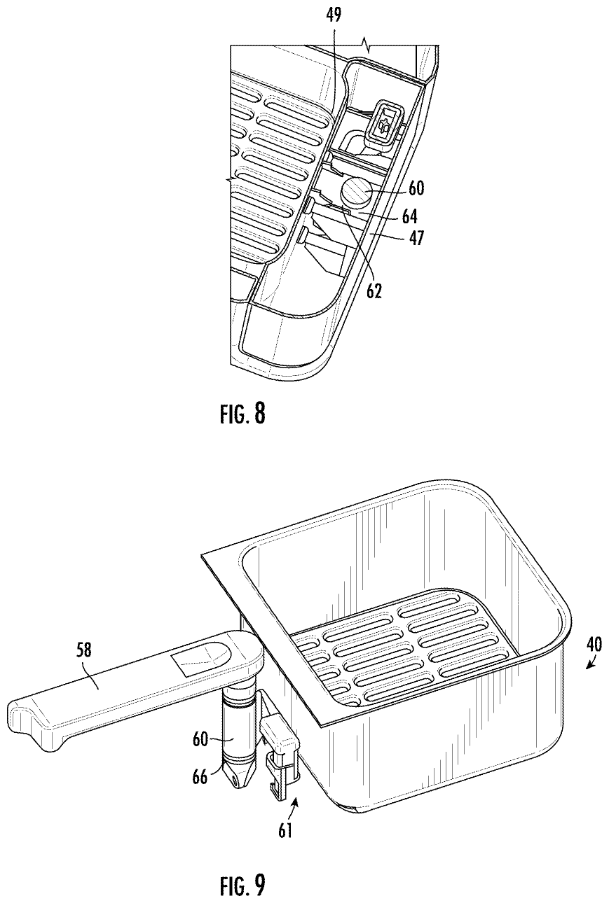

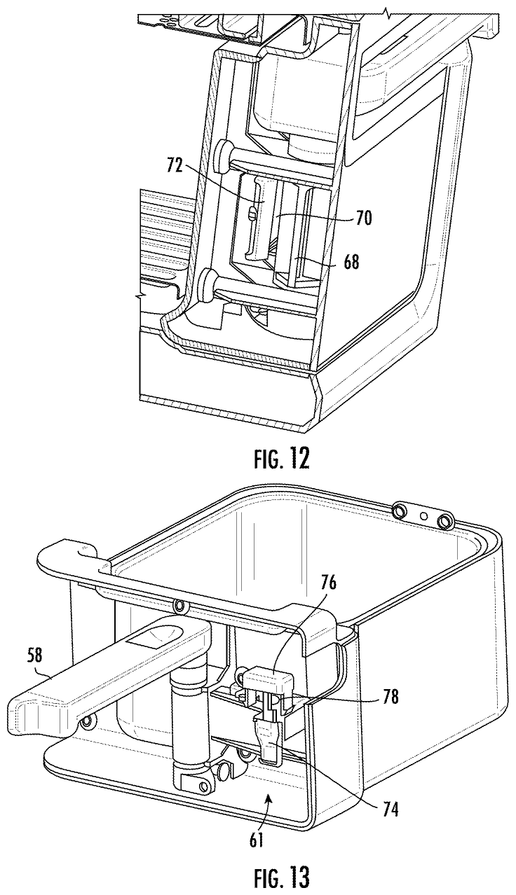

In some embodiments, the handle 46 is configured so that it locks in the extended position. Such locking can assure that the handle 46 is stable while the cooking basket 40 to which it is attached is handled by a user, as the cooking basket 40 may contain hot food. Locking of the handle 46 is achieved via a locking mechanism 61 (see FIGS. 7-14) that is mounted within the front wall 42 of the cooking basket 40. The post 60 of the handle 46 is captured by two pairs of fingers 62 that extend forwardly from the rear panel 47 of the front wall 42 and by two pairs of fingers 64 that extend rearwardly from the front panel 49 of the front wall 42 (see FIGS. 8 and 11). The fingers 62, 64 fit within grooves 66 in the post 60. A latch 68 extends much of the length of the post 60 and projects radially outwardly in a direction opposite the grasping portion 58 (see FIGS. 7, 11 and 12). A pivoting latch 70 (FIGS. 11-14) with a hook 72 at one end is pivotally mounted on the rear panel 47 of the front wall 42 and can pivot about a vertical axis; the hook 72 is positioned rearwardly of the post 60. At the opposite end, the latch 70 has a vertically-disposed ramp 74 (FIG. 11). A push button 76 is accessible from the upper surface of the front wall 42. A shaft 78 extends downwardly from the push button 76 and is positioned so that its lower end engages the ramp 74. The latch 70 is biased (e.g., via a spring or the like) toward an orientation in which the hook end of the latch 70 is forward.

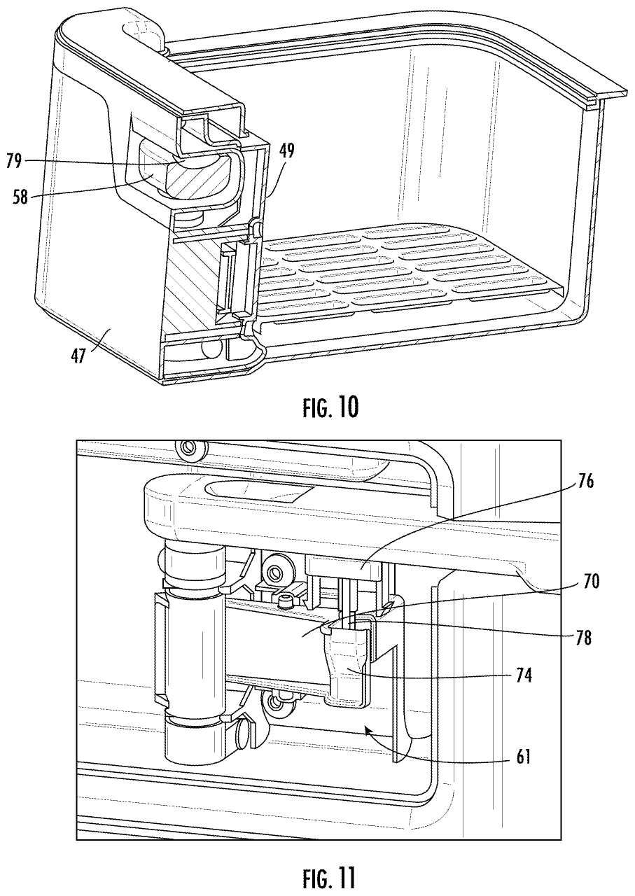

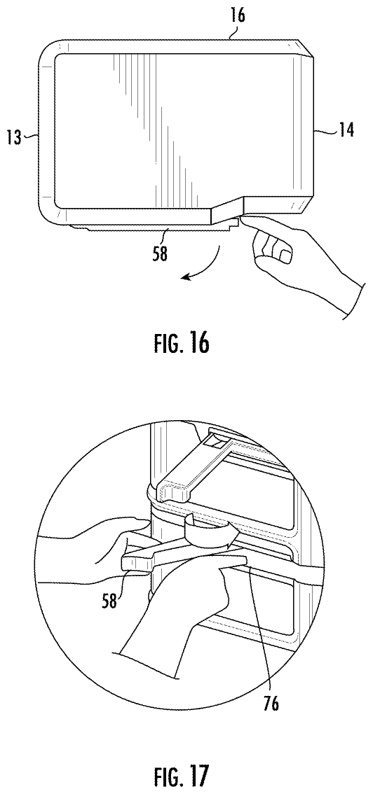

In the retracted position (FIGS. 6, 11 and 12), the handle 46 is rotated so that the grasping portion 58 is positioned within the recesses 44, 38, and the latch 68 extends toward the side wall 13. In some embodiments, the handle 46 may be maintained in this position by a locking feature (e.g., a recess 79 in the grasping portion 58 and a mating projection (not shown) extending downwardly from the upper edge of the recess 44 (see FIG. 10). A user can extend the handle 46 by pulling the free end of the grasping portion 58 away from the recesses 44, 38 (see FIG. 16) After overcoming the resistance provided by the aforementioned locking feature, the handle 46 pivots about the longitudinal axis defined by the post 60. After almost 90 degrees of rotation, the latch 68 of the handle 46 contacts the latch 70. Further rotation causes the latch 70 to pivot sufficiently to allow the latch 68 to “clear” and pass beyond the latch 70. At this point the latch 68 engages the hook 72 of the latch 70, thereby preventing counter-rotation back toward the retracted position (see FIGS. 9 and 14). Also, the edge of the grasping portion 58 contacts the end of the recess 44, which ceases rotation of the handle 46 toward the extended position (FIG. 5). As a result, the handle 46 is locked into the extended position, as is desirable when the cooking basket 40 is removed from the housing 11.

In some embodiments, the handle 46 cannot be returned to the retracted position unless the cooking basket 40 is returned to its location in the housing 11; however, in this embodiment the handle 46 can return to the retracted position outside of the housing 11. In either event, with the handle 46 in the extended position, a user can depress the push button 76 (FIG. 17). This action causes the shaft 78 to descend; lowering of the shaft 78 as it engages the ramp 74 forces the end of the latch 70 forwardly, which in turn causes the latch 70 to pivot. This action draws the hook 72 of the latch 70 rearwardly, which creates clearance for the latch 68 and enables the handle 46 to rotate toward the retracted position.

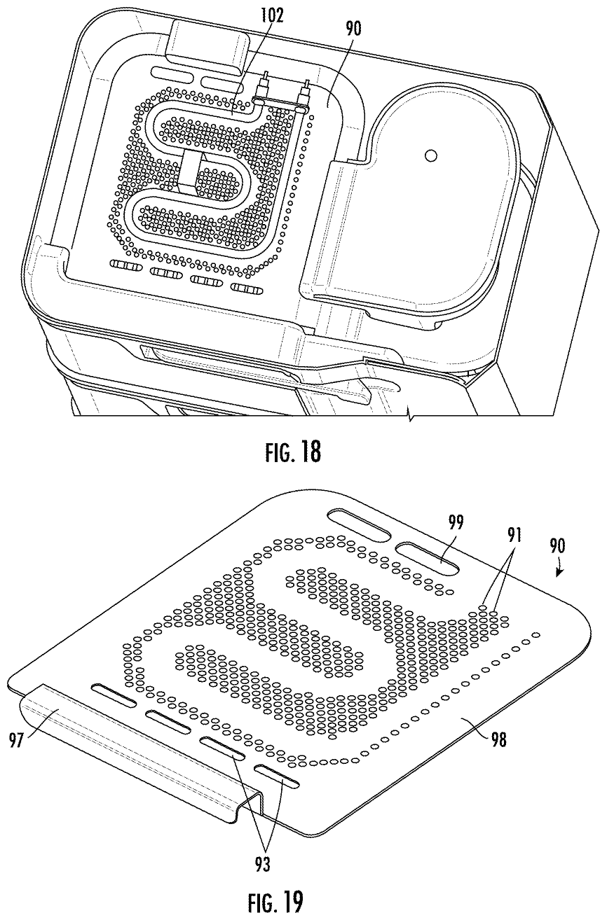

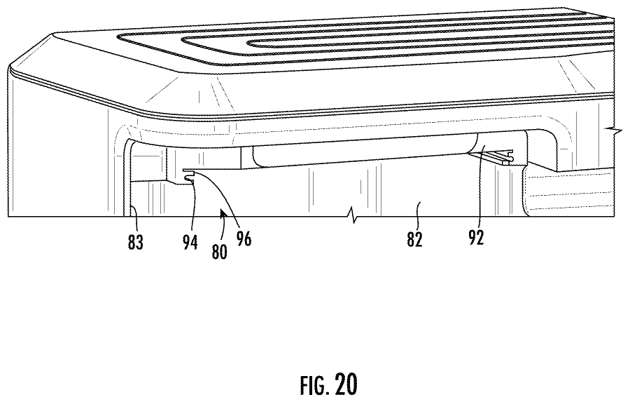

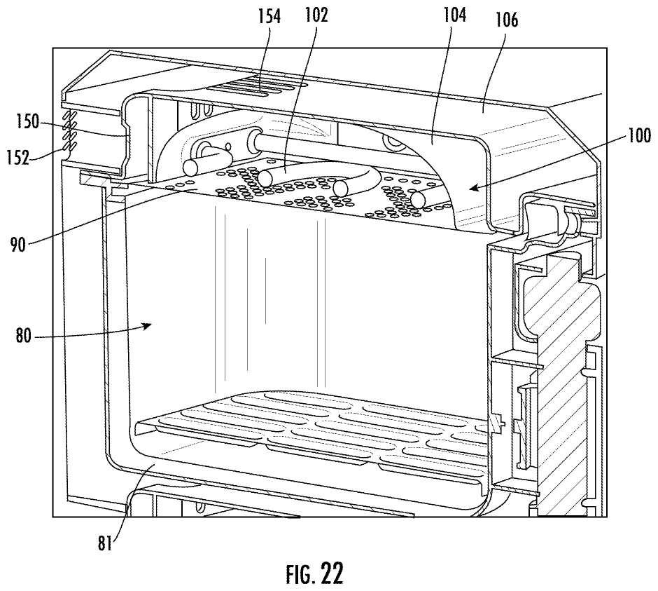

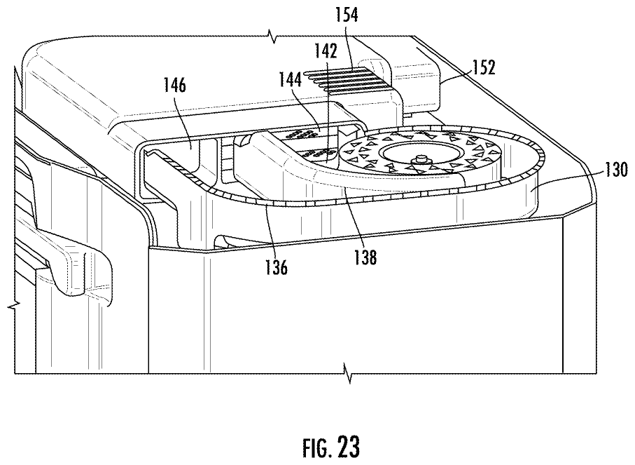

Each of the cooking baskets 40 is positioned for cooking within a respective cooking compartment 80, which are in a vertically stacked arrangement within the housing 11 (see FIG. 22). Each cooking compartment 80 includes a floor 81, side walls 82, 83, and a rear wall 84 (which in the illustrated embodiment are formed as a single component—see FIG. 13). The front side of the cooking compartment 80 is open for inserting and removing the cooking basket 40. The top of each cooking compartment 80 is formed by a splatter shield 90 (FIGS. 18-20), which will be described in greater detail below. The splatter shield 90 is held in place by an open frame 92 (FIGS. 15 and 20), mounted on top of the side walls 82, 83 and the rear wall 84, which has grooves 94 on each side to receive the splatter shield 90. The frame 92 also has grooves 96 that receive the rim 54 of the cooking basket 40 (FIGS. 20 and 22).

A heating compartment 100 is positioned above each of the cooking compartments 80. One of the heating compartments 100 is shown in FIG. 22. A heating element 102 is positioned above the splatter shield 90. A domed heat reflector 104 is mounted to and above the heating element 102 and the splatter shield 90. A heat insulator 106 is mounted on top of and surrounds the heat reflector 104.

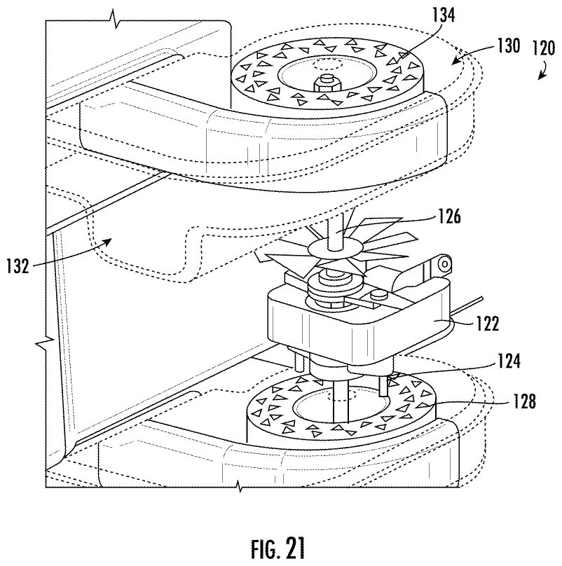

Referring now to FIG. 21, the recirculation system 120 is shown therein. A motor 122 is mounted rearwardly of the control panel 22 beside the cooking compartments 80. Shafts 124, 126 extend upwardly and downwardly from the motor 122. “Squirrel cage”-style rotary fans 128, 130 are mounted to the shafts 124, 126 respectively. In the illustrated embodiment, both fans 128, 130 rotate as the motor 122 operates.

Referring to FIGS. 18-23, each fan 124, 126 resides within a blower housing 130. Each blower housing 130 includes an intake chamber 132 and an exhaust chamber 134 that are separated by a partition 135 having a horizontal divider 136 and a vertical wall 138. A cover 140 covers the intake and exhaust chambers 132, 134. The exhaust chamber 134 has an outlet 142 above the divider 136 that aligns with an opening 144 (FIG. 22) in the heat reflector 104. Thus, rotation of the fan 128 directs air from the exhaust chamber 134 through the outlet 142 and the opening 144 into the heating compartment 100, where the air is heated. Heated air from the heating compartment 100 passes through holes 91 in the splatter shield 90 into the cooking compartment 80. From there, air is directed through slots 93 in the splatter shield 90 into the space defined by the heat insulator 106 and the heat reflector 104, then through an outlet 146 in the heat insulator 106 that leads to the intake chamber 132 of the blower housing 130. The fan 128 draws air from the intake chamber 132 through the fan 128 and into the exhaust chamber 134, thereby restarting the air cycle. Slots 99 in the splatter shield 90 allow steam to vent from the cooking compartment 80 through a vent 150 in the rear portion of the heat insulator 106 (which leads to a vent 152 that opens to the atmosphere through the rear wall 16). Another vent 154 is positioned in the upper surface of the heat insulator 106 above the ends of the heating element 102 allows air to be drawn into the space defined by the heat insulator 106 and heat insulator 104. The air is heated as it passes through this space and through an outlet 146 in the heat insulator 106 that leads to the intake chamber 132 of the blower housing 130.

The controller 200 (typically one or more microprocessors) is operatively associated with the control panel 22 as noted above, and is also operatively connected with the heating elements 102 and the motor 122.

When a user wishes to operate the air fryer 10, the user makes selections on the control panel 22 (which may include cooking time, temperature, and the like). The user also removes one or both of the cooking baskets 40, 41 by extending the handle 46 to the extended position of FIG. 5, which locks the handle 46 in the extended position and enables the user to easily remove the cooking basket 46 from its cooking compartment 80. The user loads the cooking basket 40 with food to be cooked, replaces the cooking basket 40 in the cooking compartment 80 by inserting the rim 54 into the grooves 96 in the frame 92, and starts the cooking process through the control panel 22. In some embodiments, the air fryer 10 may include one or more sensors (not shown) operatively connected with the controller 200 that confirm that the handle 46 is extended before cooking can commence and/or confirm that the cooking basket 40 is properly seated in the cooking compartment 80.

During cooking, the controller 200 controls the operation of the motor 122 and the heating elements 102. Because the air fryer 10 utilizes a single motor 122 to drive both fans 128, 130, air flows through both cooking compartments 80 even if one of the cooking compartments 80 is not loaded with food. The use of a single motor 122 can both reduce the cost of the air fryer 10 (by eliminating the cost of a second motor) and can save energy (because only one motor operates).

The controller 200 may be configured to operate both of the heating elements 102 separately or simultaneously. In some embodiments, the controller 200 may be configured such that, if both cooking compartments 80 are being used, the heating elements 102 are operated in an alternating fashion. For example, one of the heating elements 102 may be operated for 30 seconds while the other heating element 102 is deactivated, then the controller 200 may switch on the second heating element 102 for 30 seconds while switching off the first heating element 102. This process of cycling the heating elements 102 may enable higher wattage heating elements to be employed without concern for electrically overloading a typical household electrical circuit.

Because the cooking compartments 80 are arranged in a stacked fashion, they may be shorter in height than a typical air fryer cooking compartment. In some embodiments, the cooking compartments 80 may be between about 3 and 4.5 inches in height, and/or may be between about 5 and 8 inches in width and between about 5 and 8 inches in depth. Because each cooking compartment 80 can have its own heating element 102, each of the heating elements 102 may be positioned relatively near the cooking food. The splatter shield 90 discussed above is disposed between the heating element 102 and the food in the cooking compartment 80 immediately below it to reduce the amount of splattered material from the food (e.g., oils, fats, water, etc.) from reaching the heating element 102 (splattered food matter on the heating element 102 can cause unwanted smoke and odor, among other undesired side effects).

As shown in FIG. 18, the holes 91 in the main panel 98 of the splatter shield 90 are arranged in a pattern so that they are not directly below the heating element 102. For example, as can be seen in FIGS. 18 and 19, the main panel 98 of the splatter shield 90 has solid portions that directly underlie the heating element 102, whereas the holes 91 are located in positions that are horizontally offset from the heating element 102. As such, the holes 91 can provide the pathways needed for air flow from the heating compartment 100 to the cooking compartment 80, but with much less opportunity for splatter from cooking food to reach the heating element 102.

In addition, the splatter shield 90 is slidably mounted in the grooves 94 in the frame 92, which can allow the splatter shield 90 to be removed for cleaning of the splatter shield 90 and/or the heating compartment 100. As shown in FIG. 20, the splatter shield 90 may have a tab 97 that extends upwardly from its front edge. The tab 97 may serve as an easy structure to grasp when sliding the splatter shield 90 out of or into the grooves 94, and may also provide a location for an instructional or warning message (e.g., “REMOVE FOR CLEANING”).

When cooking is complete, the user can remove the cooking basket 40 from the cooking compartment 80, remove the cooked food, and return the cooking basket 40 to the cooking compartment (perhaps after cleaning). The user can return the handle 46 to the retracted position by pressing the push button 76, which, as described above, forces the ramp 74 of the latch 70 forwardly (thereby forcing the hook 72 rearwardly, which allows the latch 68 on the post 60 to clear the hook 72 and permit the handle 46 to pivot to the retracted position.

Those of skill in this art will appreciate that the air fryer 10 may take other forms. For example, in some embodiments the cooking compartments 80 may be “side-by-side” rather than vertically stacked as illustrated. In other embodiments, additional cooking compartments may be included (for example, three cooking compartments may be vertically stacked), or only a single cooking compartment may be included.

The handle configuration may also differ. As one example, locking of the handle 46 into the extended position may be achieved differently (e.g., via a nub and detent or the like, which may be located at any number of locations on the post 60 and/or the front wall 42). Either or both of the recesses 44, 38 may be omitted. In some embodiments, the grasping portion 58 of the handle 46 may have a telescoping configuration that is extended for movement and handling of the cooking basket 40 but is retracted/shortened for storage in the retracted position.

The splatter shield 90 may also take different configurations. Although the heating element 102 shown herein is serpentine, other heating elements may be employed, with the result that the pattern of holes 91 in the splatter shield 90 may be varied so that solid portions of the main panel 98 of the splatter directly underlie the heating element 102.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. An air-frying cooking appliance, comprising:
a housing;
a first cooking compartment defined in the housing, the first cooking compartment having an open front side,
a first heating compartment located directly above the first cooking compartment, the first heating compartment having a first heating element;
a first fan positioned to provide air to the first heating compartment;
a first cooking basket having a front wall and a cooking container, the cooking container configured to removably reside in the first cooking compartment; and
a first handle pivotally mounted to the front wall of the first cooking basket, the first handle being movable between a retracted position, in which a grasping portion of the first handle is generally parallel with the front wall of the first cooking basket, and an extended position, in which the grasping portion of the first handle is generally normal to the front wall of the first cooking basket.

2. The appliance defined in claim 1, wherein the first handle includes a post that is generally perpendicular to the grasping portion, and wherein the post defines a pivot axis for movement between the retracted and extended positions.

3. The appliance defined in claim 2, wherein the post is vertically disposed, such that the pivot axis is vertically disposed.

4. The appliance defined in claim 1, wherein the first cooking basket and/or first handle include a locking mechanism that locks the first handle in the extended position.

5. The appliance defined in claim 4, wherein the first handle includes a post that is generally perpendicular to the grasping portion, and wherein the locking mechanism comprises a first latch fixed to the post and a second latch pivotally mounted on the front wall, wherein engagement of the first and second latches locks the handle in the extended position.

6. The appliance defined in claim 4, wherein the first cooking basket includes a release member associated with the locking mechanism that releases the first handle from the extended position.

7. The appliance defined in claim 1, wherein the front wall of the first cooking basket includes a recess, and wherein the grasping portion resides at least partially in the recess in the retracted position.

8. The appliance defined in claim 1, further comprising (a) a second cooking compartment in the housing, the first cooking compartment located beneath the second cooking compartment; (b) a second heating compartment with a second heating element, the second cooking compartment being located directly beneath the second heating compartment; and (c) a second cooking basket removably residing in the second cooking compartment.

9. The appliance defined in claim 8, further comprising a second fan positioned to provide air to the second cooking compartment.

10. The appliance defined in claim 9, wherein the second fan is positioned to provide air along a generally horizontal path to the second heating compartment, and the first fan is positioned to provide air along a generally horizontal path to the first heating compartment.

11. The appliance defined in claim 10, further comprising a motor operatively connected to the first and second fans.

12. The appliance defined in claim 8, further comprising a controller operatively connected with the motor, the first heating element, and the second heating element.

13. The appliance defined in claim 12, wherein the controller is configured to deactivate the first heating element when the second heating element is activated, and to deactivate the first heating element when the second heating element is activated.

14. An air-frying cooking appliance, comprising:
a housing;
a first cooking compartment defined in the housing having an open front side,
a first heating compartment located directly above the first cooking compartment, the first heating compartment having a first heating element;
a first fan positioned to provide air to the first heating compartment;
a first cooking basket having a front wall and a cooking container, the cooking container configured to removably reside in the first cooking compartment; and
a first splatter shield removably interposed between the first cooking basket and the first heating compartment, the first splatter shield comprising a main panel, the main panel including apertures allowing air to flow from the first heating compartment to the first cooking compartment;
wherein the apertures are arranged on the main panel of the first splatter shield so that solid portions of the main panel are directly beneath the heating element.

15. The appliance defined in claim 14, wherein the first heating element follows a serpentine path.

16. The appliance defined in claim 14, wherein the first fan is positioned to provide air to the first heating compartment along a generally horizontal path.

17. The appliance defined in claim 14, wherein the first splatter shield further comprises a front tab extending from the main panel, the front tab being positioned in front of the first heating compartment.

18. The appliance defined in claim 17, wherein the front tab includes visual markings for use of the appliance.

19. The appliance defined in claim 14, wherein the cooking basket is between about 3 and 4.5 inches in height.

20. The appliance defined in claim 14, further comprising (a) a second cooking compartment in the housing, the first cooking compartment located beneath the second cooking compartment (b) a second heating compartment with a second heating element, the second cooking compartment being located directly beneath the second heating compartment; and (c) a second cooking basket removably residing in the second cooking compartment.
